(19) United States
(12) Patent Application Publication
(10) Pub. No.: US 2021/0341020 A1
(43) Pub. Date: Nov. 4, 2021

(54) DEVICE FOR REDUCING TORSIONAL VIBRATIONS IN A DRIVE TRAIN

(71) Applicant: ZF FRIEDRICHSHAFEN AG, Friedrichshafen (DE)

(72) Inventors: Stefan HERZOG, Coburg (DE); Laura RÖDER, Prosselsheim (DE); Marcel WINKLER, Rodewisch (DE); Miroslav CIZEK, Plzen 3 (CZ); Jakub SKLENICKA, Plzen 3 (CZ); Monika RÖßNER, Donnersdorf (DE); Gerald VIERNEKES, Hassfurt (DE); Manfred ZIMMER, Zeil (DE)

(21) Appl. No.: 17/273,061

(22) PCT Filed: Sep. 4, 2019
(86) PCT No.: PCT/EP2019/073563

§ 371 Date: Mar. 3, 2021

(30) Foreign Application Priority Data
Sep. 6, 2018 (DE) 10 2018 215 114.8

(51) Int. Cl. F16D 3/12; F16F 15/121; F16D 3/84

(52) U.S. Cl. CPC F16D 3/12; F16F 2226/04; F16D 3/843; F16F 2232/02; F16F 2236/08; F16F 2230/04; F16D 2250/0084; F16D 2200/0004; F16D 2300/08; F16D 2300/06; F16F 2230/30; F16D 2300/12; F16D 2300/22; F16F 2224/0208; F16F 15/121

(57) ABSTRACT

An apparatus for damping torsional vibrations in a drivetrain, including a drive device and an output device, which drive device and output device are arranged so as to be rotatable around a common axis, a damping device that connects the drive device and the output device to one another, and a thrust bearing device for axial support of drive device and the output device. The drive device, cover device, and thrust bearing device are arranged such that a partially enclosed spatial region is formed, and at least one damping element of the damping device is arranged in the spatial region. Elements of the drive device, the cover device, the output device and the thrust bearing device are arranged to inhibit liquid entry into the spatial region.

### CROSS REFERENCE TO RELATED APPLICATIONS

This is a U.S. national stage of Application No. PCT/EP2019/073563 filed Sep. 4, 2019. Priority is claimed on German Application No. DE 10 2018 215 114.8 filed Sep. 6, 2018 the content of which is incorporated herein by reference.

### BACKGROUND OF THE INVENTION

### 1. Field of the Invention

The invention is directed to an apparatus for damping torsional vibrations in a drivetrain, comprising a drive device and an output device, wherein drive device and output device are arranged to be rotatable around a common axis, a damping device that connects the drive device and output device to one another, a thrust bearing device for axial support of drive device and output device, wherein the drive device, a cover device and the thrust bearing device are arranged relative to one another such that a partially enclosed spatial region is formed, wherein at least one damping element of the damping device is arranged in the spatial region.

The invention is further directed to a method for producing an apparatus for damping torsional vibrations in a drivetrain, comprising:
providing a drive device and an output device such that the drive device and output device are rotatable around a common axis,
providing a damping device that connects drive device and output device to one another,
providing a thrust bearing device for axial support of drive device and output device,
providing a cover device,
arranging drive device, output device, cover device and thrust bearing device relative to one another such that a partially enclosed spatial region is formed, and
arranging at least one damping element of the damping device in the spatial region.

### 2. Description of Related Art

Known torsional vibration dampers comprise a drive device and an output device, and the drive device and output device are arranged so as to be rotatable around a common axis. Further, a damping device connects the drive device and the output device to one another. The drive device and output device are supported at the common axis both radially and axially by a thrust bearing device. In order to keep the installation space compact, the drive device, output device and thrust bearing device are arranged relative to one another so as to form a partially enclosed spatial region in which the damping device is arranged. Known damping devices comprise springs arranged in an arcuate configuration and which absorb torsional vibrations. The springs contact corresponding limits in the damping device. Also, corresponding turns of a spring contact each other, which leads to premature wear and therefore to failure of the torsional vibration damper.

A torsional vibration damper that has a drive element and an output element and in which the drive element and output element are rotatable around a common axis is known from EP 2 423 531 A1. Further, the drive element and output element are connected to one another via arcuately arranged springs for damping torsional vibrations. Further, the springs are provided with a coating that enhances resistance to wear.

A further torsional vibration damper known from GB 2 149 059 A has springs with a coating, for example, nylon, which reduces friction and enhances resistance to wear.

One of the disadvantages of the known torsion damper devices is that while interior elements, particularly the springs, are protected against wear, they are not protected against other, external environmental influences.

### SUMMARY OF THE INVENTION

An object of one aspect of the present invention is an apparatus for damping torsional vibrations in a drivetrain and a method for producing an apparatus for damping torsional vibrations which provide improved protection against external environmental influences. A further object of the present invention is to provide an alternative apparatus for damping torsional vibrations and an alternative method for producing an apparatus for damping torsional vibrations.

In an apparatus for damping torsional vibrations in a drivetrain, comprising a drive device and an output device, which drive device and output device are arranged so as to be rotatable around a common axis, a damping device that connects the drive device and the output device to one another, a thrust bearing device for axial support of drive device and output device, wherein the drive device, a cover device, and the thrust bearing device are arranged relative to one another such that a partially enclosed spatial region is formed, and at least one damping element of the damping device is arranged in the spatial region, the present invention meets the above-stated objects in that elements of drive device, cover device, output device and thrust bearing device are arranged relative to one another so as to inhibit liquid entry, particularly so as to inhibit water entry, and/or configured for the purpose of reducing liquid entry into the spatial region.

In a method for producing an apparatus for damping torsional vibrations in a drivetrain, comprising the steps:
providing a drive device and an output device such that the drive device and output device are rotatable around a common axis,
providing a damping device that connects the drive device and the output device to one another,
providing a thrust bearing device for axial support of the drive device and the output device,
providing a cover device,
arranging the drive device, the output device, the cover device and the thrust bearing device relative to one another such that a partially enclosed spatial region is formed, and
arranging at least one damping element of the damping device in the spatial region.

The present invention meets the above-stated objects in that elements of the drive device, the cover device, the output device, and the thrust bearing device are arranged relative to one another to inhibit liquid entry, particularly so as to inhibit water entry, and/or configured for the purpose of reducing liquid entry into the spatial region.

One of the advantages achieved in this way is to make possible an enhanced protection against external environmental influences, particularly against intruding liquids. Beyond this, the life of the apparatus is prolonged.

Further features, advantages and further embodiment forms of the invention are described in or will be apparent from the following.

According to an advantageous further development, the damping device comprises at least one damping element formed to be liquid-repellent. The advantage herein consists in that, even when liquid enters the spatial region and impinges on the damping element, the liquid is drained off again and/or is inhibited from precipitating on the damping element so that the life of the damping element and, therefore, of the damping device as a whole is extended.

According to another advantageous further development, the at least one damping element is provided with a liquid-repellent coating and/or with an anti-corrosion coating. Accordingly, the life of the damping device is further extended while facilitating production at the same time.

According to another advantageous further development, at least one of the devices, particularly all of the devices, are acted upon by a lubricant, particularly a grease, which is liquid-repellent, particularly water-repellent. The advantage herein consists in that liquid entry is also prevented as far as possible in corresponding contact points between devices and/or elements of the respective devices while at the same time reducing friction between the component parts by the grease. Accordingly, the life of the apparatus is further extended on the whole.

According to another advantageous further development, at least one element of drive device, output device and/or cover device which outwardly defines the spatial region is formed without holes and/or is provided with at least one hole that is closed. In this way, the probability of liquid entering the spatial region is further reduced. Beyond this, mounting is facilitated: for example, mounting holes for mounting the apparatus can continue to be used, since they are closed subsequently after corresponding assembly of the apparatus, which likewise minimizes the probability of liquid entering the spatial region.

According to another advantageous further development, a spring device is arranged that provides a predeterminable axial preloading on at least one thrust bearing element of the thrust bearing device so that a determined preloading force on the thrust bearing element does not fall below a certain value. The advantage herein consists in that elements are correspondingly pressed together in axial direction with a minimum force, which likewise minimizes intermediate spaces between the elements. This reduces the probability of liquid entry.

According to another advantageous further development, the spring device is arranged at the cover device. This allows a simple and reliable arrangement of the spring device.

According to another advantageous further development, the spring device is arranged between the cover device and the thrust bearing device such that it outwardly limits the spatial region. In this way, the spatial region can be outwardly delimited in a simple and simultaneously reliable manner; additional component parts or component elements can then be omitted.

According to another advantageous further development, the thrust bearing element with which the spring device cooperates is arranged on the radial inner side of the spring device. This allows existing or temporarily occurring intermediate spaces to be minimized particularly in the area of the rotational axis, which further reduces the probability of liquid entry.

According to another advantageous further development, the thrust bearing device comprises at least one thrust bearing element, in particular a thrust ring, which has a larger extension in axial direction than an element of the output device adjoining in radial direction, and the at least one thrust bearing element of the thrust bearing device abuts an element of the output device without axial intermediate space. In this way, openings or intermediate spaces of the spatial region are covered by the thrust bearing element, and the spatial region is protected from liquid entry.

According to another advantageous further development, a spacer element is arranged between an inner side of the drive device and a thrust bearing element and formed such that the spacer element at least partially wraps around the thrust bearing element in radial and axial direction, and the spacer element is formed as sheet metal in particular. The advantage herein again consists in that the probability of liquid entry is further reduced through the axial and radial gripping. A simple and cost-effective production is made possible when the spacer element is formed as sheet metal.

Further important features and advantages of the invention will be apparent from the subclaims, drawings and associated description of the figures referring to the drawings.

It will be appreciated that the features which have been mentioned above and which will be described in the following are usable not only in the indicated combinations but also in other combinations or individually without departing from the scope of the present invention.

### BRIEF DESCRIPTION OF THE DRAWINGS

Preferred constructions and embodiment forms of the invention are shown in the drawings and described more fully in the following description Like reference characters designate like or similar or functionally like component parts or elements.

The drawings show schematically and in cross section:

FIG. 1 is a torsion damper;

FIG. 2 is a known torsion damper;

FIG. 3 is a torsion damper;

FIG. 4 is a sealing disk;

FIG. 5 is a pressure equalization element;

FIG. 6 is a torsion damper;

FIG. 7 is a torsion damper; and

FIG. 8 is a method according to one aspect of the present invention.

### DETAILED DESCRIPTION OF THE PRESENTLY PREFERRED EMBODIMENTS

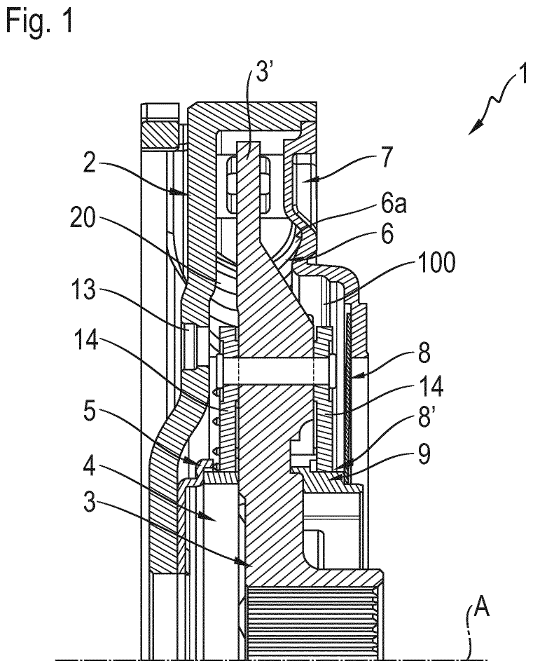

FIG. 1 shows a torsion damper according to an embodiment form of the present invention schematically and in cross section.

A torsion damper 1 is shown in detail in FIG. 1. The torsion damper 1 has a drive device in the form of a primary flywheel 2, which has a mounting hole or mounting opening 13 extending in axial direction. The mounting hole 13 is closed after the torsion damper 1 is mounted. The mounting hole 13 can serve, for example, as a lubricant fill opening, for example, for filling with grease. The primary flywheel 2 is mounted to be rotatable around an axis A. Also shown is an output device in the form of a hub 3 that has a radially outer region 3′ and at which centrifugal masses 14 are arranged on the left-hand side and right-hand side in cross section in FIG. 1. Primary flywheel 2 and hub 3 with its radially outer region 3′ are rotatable relative to one another around the common axis A and are connected to one another via damping elements of a damping device in the form of compression springs 6. As an alternative to a hub 3, as is shown, it is also conceivable to combine the hub with a hub disk.

On the axial side remote of the primary flywheel 2, i.e., a secondary side, a cover plate 7 is arranged at the primary flywheel 2 such that the compression springs 6 substantially in a U-shaped spatial region 100, which is formed by the primary flywheel 2, which is substantially L-shaped in cross section, and the cover device which adjoins the primary flywheel 2 and extends substantially inward in radial direction in the form of a cover plate 7. Further, a spring device extending substantially in radial direction in the form of a plate spring 8 is arranged. On the one hand, the spring device is connected to the cover plate 7 or is supported at the latter and, on the other hand, exerts a preloading force on a supporting ring 9 which is located farther radially inward and arranged on the radial outer side of the hub 3. As an alternative to the plate spring 8, it is also conceivable to correspondingly arrange a sealing plate or the like arranged in particular at the hub 3 so as to be fixed with respect to rotation relative to it. To limit the spatial region 100 radially inward on the primary side, a spacer element in the form of a washer 5, which is axially and radially angled multiple times, is first arranged between the primary flywheel 2 in the region of the hub 3 from left to right in axial direction. A thrust ring 4 is arranged on the radial inner side of the washer 5. The thrust ring 4 has a larger axial extension than the flywheel masses 14 that are connected to the hub 3 and that are arranged radially outwardly of the thrust ring 4 or supporting ring 9 on both sides of the radially outer region 3′ of the hub 3. This minimizes intermediate spaces and accordingly reduces the probability of a possible intrusion of water. The washer 5 is formed in such a way that, on the one hand, it covers the clearance between the primary flywheel 2 and the thrust ring 4 in axial direction and, on the other hand, projects over the thrust ring 4 in axial direction on the radial outer side of the thrust ring 4 such that through-openings toward region 100 are also minimized in this case. The thrust ring 4, washer 5, plate spring 8 and supporting ring 9 are elements of a thrust bearing device of the torsion damper 1.

On the output side, that is, on the right-hand side of hub 3 referring to FIG. 1, possible axial and radial openings are prevented in that, as was mentioned above, the supporting ring 9 is pressed against by the plate spring 8, which likewise abuts at a projection in the hub 3 in axial direction and in radial direction so that the probability of liquid entering region 100 is further reduced.

The compression springs 6 further have a liquid-repellent coating 6a as well as a corrosion-inhibiting coating. Beyond this, a lubricant 20, particularly in the form of a grease which, in particular, is not water-soluble and does not absorb water, is used between at least two of the above-mentioned component parts of the torsion damper.

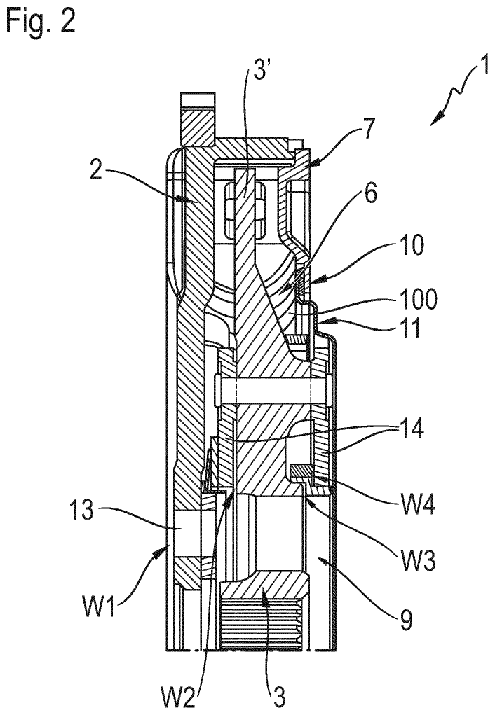

FIG. 2 shows a known torsion damper. FIG. 2 shows a torsion damper 1 in detail. As in the torsion damper 1 according to FIG. 1, the torsion damper 1 according to FIG. 2 has a primary flywheel 2 that cooperates via damping elements 6 with a radially outer region 3′ of a hub 3 for damping torsional vibrations. In a manner analogous to FIG. 1, a cover plate 7 is likewise arranged at the primary flywheel 2 and extends radially inward through to the region of a supporting ring 9 via a thrust disk 10 and a sealing plate 11.

In contrast to the torsion damper 1 according to FIG. 1, the torsion damper 1 according to FIG. 2 has mounting openings 13 in the primary flywheel 2 that are not closed. These mounting openings 13 form a first water inlet orifice W1. Further, the centrifugal masses 14 arranged at the hub 3 inwardly in radial direction are not shielded by a washer or a correspondingly formed thrust ring 4. To this extent, water can enter region 100 of compression springs 6 via a second water inlet orifice W2. On the output side, the supporting ring 9 engages around the hub 3 particularly in axial direction as well as in radial direction as in FIG. 1. However, as a result of this, during corresponding axial relative movements between hub 3 and supporting ring 9, a third water inlet orifice W3 is made possible between hub 3 and supporting ring 9. A fourth water inlet orifice W4 is made possible between the sealing plate 11 supported in axial direction substantially on the support ring 9 and the centrifugal mass 14 on the output side of the hub 3. Accordingly, overall, water can enter in axial direction via the water inlet orifices W1, W4 and can enter spatial region 100 either directly via the radially extending water inlet orifice W3 or, finally, indirectly via the radially extending water inlet orifice W2.

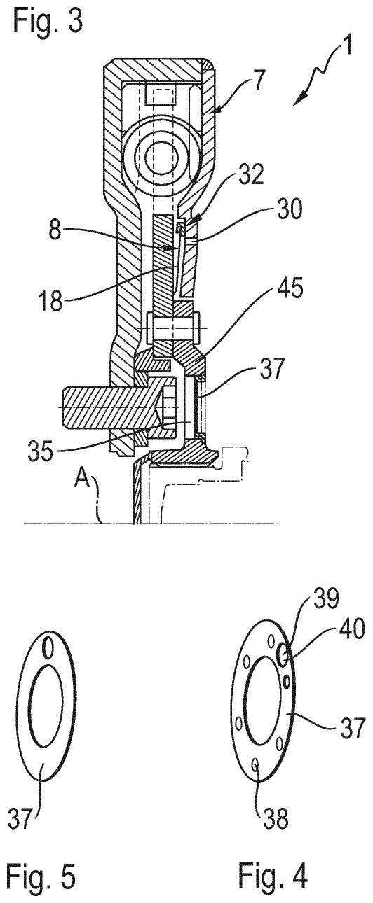

FIG. 3 shows an apparatus for damping torsional vibrations as was already described in FIGS. 1 and 2 and which is comparable in principle. However, in this case, an opening 30 is provided at the cover plate 7 through which water that has collected between the plate spring 8, formed in this instance more in the manner of a diaphragm spring 18, and the cover plate 7 exits. A plurality of openings 30 can also be provided on a common radius or on a different radius. The opening 30 is located farther radially inward in radial direction viewed from the rotational axis A with respect to a radial position of a contact point 32 of the diaphragm spring 18 with cover plate 7.

It should also be noted here that the mounting openings 35 depicted in this instance are provided in an output element 45 connected to the hub 3 by riveting, and further mounting openings which are distributed around the rotational axis A are sealed by an individual sealing disk 37. As is shown in FIG. 4, the sealing disk 37 can be provided with one or, as in the present case, with a plurality of recesses 38, which can facilitate mounting of the sealing disk 37. In addition, as is shown here, the sealing disk 37 can be provided with an opening 39 closed in turn with a pressure equalization element 40. Pressure fluctuations in the apparatus 1, which are brought about, for example, by temperature fluctuations, can be compensated by the pressure equalization element 40. Temperature compensation elements 40 can be used in this instance and advantageously glued. It should be mentioned that the pressure equalization element or elements 40 can, of course, also be provided at other locations, which are advantageously located close to the rotational axis A. FIG. 5 shows a pressure equalization element such as that shown in FIG. 4 but without the recesses for mounting.

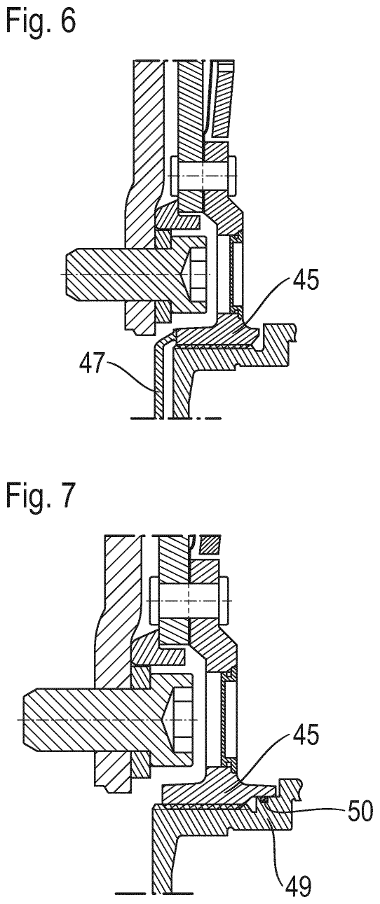

FIG. 6 shows a section of an apparatus for damping torsional vibrations 1 such as that already shown in FIG. 3 but in which the output element 45 is open rather than closed radially inward as shown in FIG. 3. The open area is closed so as to be tight against liquid in this instance by a protective cap 47, which can advantageously be produced from plastic or sheet metal.

FIG. 7 shows a construction similar to that already described referring to FIG. 6 but in which the output element 45 is formed open radially inward. The output element is closed radially inward in a liquid-tight manner only by mounting an output shaft 49 in the output element 45, a sealing element 50, in the form of an 0-ring in this instance, being provided between the output element 45 and the output shaft 49.

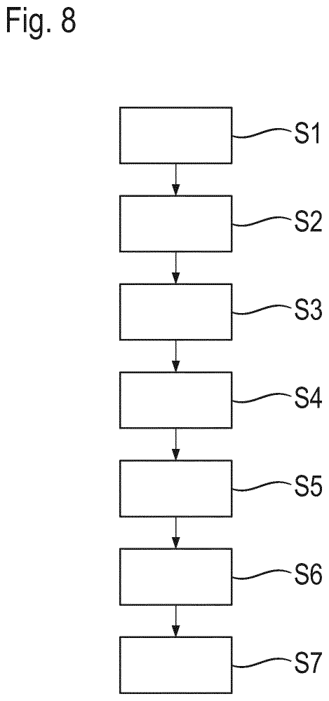

FIG. 8 shows steps of a method according to an embodiment form of the present invention.

Steps of a method for producing an apparatus for damping torsional vibrations in a drivetrain are shown in FIG. 8.

The method comprises the following:

In step S1, a drive device and an output device are provided in such a way that the drive device and output device are rotatable around a common axis.

In S2, a damping device, which connects the drive device and output device to one another, is provided.

In S3, a thrust bearing device is provided for axial support of drive device and output device.

In S4, a cover device is provided.

In S5, the drive device, the output device, the cover device, and the thrust bearing device are arranged relative to one another such that a partially enclosed spatial region is formed.

In S6, at least one damping element of the damping device is arranged in the spatial region.

In S7, elements of the drive the device, the cover device, the output device, and the thrust bearing device are arranged relative to one another so as to inhibit liquid entry, particularly water entry and/or are configured to reduce liquid entry into the spatial region.

In summary, at least one of the embodiment forms of the invention provides at least one of the following features:
Removal of all, in particular unnecessary, openings, holes or the like in an outer shell of a torsional vibration damper.
Optimization of axial support with respect to geometry and preloading for forming a closed sealing plane.
Water-insoluble or water-repellent lubricant, in particular grease.
Water-repellent coating of component parts, particularly of the damping elements.

In summary, at least one of the embodiment forms of the invention has at least one of the following advantages:
torsion damper with fording capability
simple production
cost-effective production
longer life
protection against external environmental influences, particularly against an intrusion of liquid, particularly water

Although the present invention has been described in terms of preferred exemplary embodiments, it is not limited thereto and may be modified in various ways.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-12. (canceled)

13. An apparatus configured to damp torsional vibrations in a drivetrain, comprising:
a drive device;
an output device, wherein the drive device and the output device are arranged to be rotatable around a common axis;
a damping device that connects the drive device and the output device to one another;
a thrust bearing device configured to axially support the drive device and the output device;
a cover device;
a partially enclosed spatial region is formed by an arrangement of the drive device, the cover device, and the thrust bearing device relative to one another; and
at least one damping element of the damping device is arranged in the partially enclosed spatial region,
wherein elements of the drive device, the cover device, the output device, and the thrust bearing device are arranged relative to one another to inhibit liquid entry, and/or configured to reduce liquid entry into the partially enclosed the partially enclosed spatial region.

14. The apparatus according to claim 13, wherein the damping device comprises at least one damping element configured to be liquid-repellent.

15. The apparatus according to claim 14, wherein the at least one damping element is provided with a liquid-repellent coating and/or an anti-corrosion coating.

16. The apparatus according to claim 13, wherein at least one of the drive device, the output device, the cover device, and the thrust bearing device are acted upon by a liquid-repellent lubricant.

17. The apparatus according to claim 13, wherein at least one element of the drive device, the output device and/or the cover device which outwardly defines the partially enclosed spatial region is at least one of:
formed without holes and
is provided with at least one hole that is closed.

18. The apparatus according to claim 13, further comprising:
a spring device is arranged to provide a predeterminable axial preloading on at least one thrust bearing element of the thrust bearing device so that a determined preloading force on is maintained above a certain value.

19. The apparatus according to claim 18, wherein the spring device is arranged at the cover device.

20. The apparatus according to claim 19, wherein the spring device is arranged between cover device and thrust bearing device such that it outwardly limits the partially enclosed spatial region.

21. The apparatus according to claim 18, wherein the at least one thrust bearing element with which the spring device cooperates is arranged on a radial inner side of the spring device.

22. The apparatus according to claim 13,
wherein the thrust bearing device comprises at least one thrust bearing element that has a larger extension in axial direction than an element of the output device adjoining in radial direction, and
wherein the at least one thrust bearing element of the thrust bearing device abuts an element of the output device without axial intermediate space.

23. The apparatus according to claim 13, further comprising:
a spacer element arranged between an inner side of the drive device and a thrust bearing element, the spacer element is formed such that the spacer element at least partially wraps around the thrust bearing element in radial and axial direction.

24. A method for producing an apparatus for damping torsional vibrations in a drivetrain, comprising:
providing a drive device and an output device such that the drive device and the output device are rotatable around a common axis;
providing a damping device that connects the drive device and the output device to one another;
providing a thrust bearing device for axial support of the drive device and the output device;
providing a cover device;
arranging the drive device, the output device, the cover device, and the thrust bearing device relative to one another such that a partially enclosed spatial region is formed; and
arranging at least one damping element of the damping device in the partially enclosed spatial region,
wherein elements of the drive device, the cover device, the output device, and the thrust bearing device are arranged relative to one another to inhibit liquid entry and/or configured to reduce liquid entry into the partially enclosed spatial region.

25. The apparatus according to claim 13, wherein elements of the drive device, the cover device, the output device, and the thrust bearing device are arranged relative to one another to inhibit water entry.

26. The apparatus according to claim 16, wherein the liquid-repellent lubricant is a grease.

27. The apparatus according to claim 26, wherein the liquid is water.

28. The apparatus according to claim 22,
wherein the at least one thrust bearing element is a thrust ring.

29. The apparatus according to claim 23, wherein the spacer element is formed as sheet metal.
